(19) United States
(12) Patent Application Publication
(10) Pub. No.: US 2024/0095102 A1
(43) Pub. Date: Mar. 21, 2024

(54) DATA PROCESSING METHOD AND APPARATUS, COMPUTER DEVICE, AND READABLE STORAGE MEDIUM

(71) Applicant: Tencent Technology (Shenzhen) Company Limited, Shenzhen (CN)

(72) Inventors: Tieming HUANG, Shenzhen (CN); Jingzhong LI, Shenzhen (CN); Bin LI, Shenzhen (CN); Hang XIANG, Shenzhen (CN); Chuwei ZENG, Shenzhen (CN)

(73) Assignee: Tencent Technology (Shenzhen) Company Limited, Shenzhen (CN)

(21) Appl. No.: 18/521,419

(22) Filed: Nov. 28, 2023

Related U.S. Application Data
(63) Continuation of application No. PCT/CN2022/135385, filed on Nov. 30, 2022.

(30) Foreign Application Priority Data
Mar. 7, 2022 (CN) 202210214514.1

(51) Int. Cl. G06F 9/54; G06Q 10/02; G06Q 10/1093

(52) U.S. Cl. CPC G06F 9/542; G06Q 10/02; G06Q 10/1093

(57) ABSTRACT

In a data processing method, an event setting interface of an event is displayed in a first application. The event setting interface includes an event data setting element and a data association control element of the event. Event setting data of the event is received from a user via the event data setting element. The event setting data of the event is sent to a second application based on a user selection of the data association control element. The first application is associated with a first service and the second application is associated with a second service that is different from the first service.

### RELATED APPLICATIONS

This application is a continuation of International Application No. PCT/CN2022/135385 filed on Nov. 30, 2022, which claims priority to Chinese Patent Application No. 202210214514.1, entitled “DATA PROCESSING METHOD AND APPARATUS, COMPUTER DEVICE, AND COMPUTER-READABLE STORAGE MEDIUM” and filed on Mar. 7, 2022. The entire disclosures of the prior applications are hereby incorporated by reference.

### FIELD OF THE TECHNOLOGY

This disclosure relates to the technical field of computers, including to a data processing method and apparatus, a computer device, and a readable storage medium.

### BACKGROUND OF THE DISCLOSURE

With the continuous development and progress of Internet technology, its impact on production and life is increasingly deepening. Electronic offices based on Internet technology may greatly reduce office costs and improve office efficiency, which makes the electronic office rapidly spread in modern enterprises.

At present, application programs related to the electronic office are becoming more abundant, and some application programs have certain business relevance. However, since the application programs are independent from each other, the business with relevance needs to be processed separately in different application programs, which results in the decrease of processing efficiency of related data.

### SUMMARY

According to various embodiments provided by this disclosure, a data processing method and apparatus, a computer device, and a non-transitory computer-readable storage medium are provided.

A first aspect of this disclosure provides a data processing method. The data processing method may be performed by a computer device, for example. In the data processing method, an event setting interface of an event is displayed in a first application. The event setting interface includes an event data setting element and a data association control element of the event. Event setting data of the event is received from a user via the event data setting element. The event setting data of the event is sent to a second application based on a user selection of the data association control element. The first application is associated with a first service and the second application is associated with a second service that is different from the first service.

Accordingly, a second aspect of this disclosure provides a data processing apparatus, including processing circuitry that is configured to display an event setting interface of an event in a first application. The event setting interface includes an event data setting element and a data association control element of the event. The processing circuitry is configured to receive event setting data of the event from a user via the event data setting element. The processing circuitry is configured to send the event setting data of the event to a second application based on a user selection of the data association control element. The first application is associated with a first service and the second application is associated with a second service that is different from the first service.

A third aspect of this disclosure also provides a non-transitory computer-readable storage medium storing instructions which when executed by one or more processors cause the one or more processors to perform the data processing method.

A fourth aspect of this disclosure provides a computer device including a memory and one or more processors, the memory storing computer-readable instructions, and when executed by the processors, the computer-readable instructions cause the one or more processors to implement the data processing method.

A fifth aspect of this disclosure provides a computer program product including computer-readable instructions, and when executed by a processor, the computer-readable instructions implement the data processing method.

Details of one or more embodiments of this disclosure are set forth in the accompanying drawings and the description below. Other features, purposes, and advantages of this disclosure will be apparent from the description, the accompanying drawings, and the claims.

### BRIEF DESCRIPTION OF THE DRAWINGS

To describe the technical solutions in the embodiments of this disclosure more clearly, the following briefly introduces the accompanying drawings. The accompanying drawings in the following description show merely some embodiments of this disclosure, and other embodiments are within the scope of the present disclosure.

FIG. 1 is a schematic diagram of a scene of data processing according to this disclosure.

FIG. 2 is a flow schematic diagram of a data processing method according to this disclosure.

FIG. 3a is a schematic diagram of a setting interface of a reservation event of a first application according to this disclosure.

FIG. 3b is a schematic diagram of a session interface of a first application according to this disclosure.

FIG. 3c is a schematic diagram of an associated application selection interface according to this disclosure.

FIG. 3d is a schematic diagram of a login verification interface according to this disclosure.

FIG. 4 is another flow schematic diagram of a data processing method according to this disclosure.

FIG. 5 is an interaction timing diagram of a data processing method according to this disclosure.

FIG. 6 is a schematic structural diagram of a data processing apparatus according to an embodiment of this disclosure.

FIG. 7 is a schematic structural diagram of a computer device according to an embodiment of this disclosure.

### DESCRIPTION OF EMBODIMENTS

Technical solutions in the embodiments of the present disclosure are described below in conjunction with the accompanying drawings. The described embodiments are merely exemplary and do not include all of the embodiments. Other embodiments shall fall within the scope of the present disclosure.

Embodiments of the present disclosure include a data processing method and apparatus, a computer device, and a readable storage medium (for example, a non-transitory computer-readable storage medium). The data processing method may be used in the data processing apparatus. The data processing apparatus may be integrated in the computer device, and the computer device may be a terminal. The terminal may be a mobile phone, a tablet computer, a notebook computer, a smart television, a wearable intelligent device, a personal computer (PC), a vehicle-mounted terminal, and other devices.

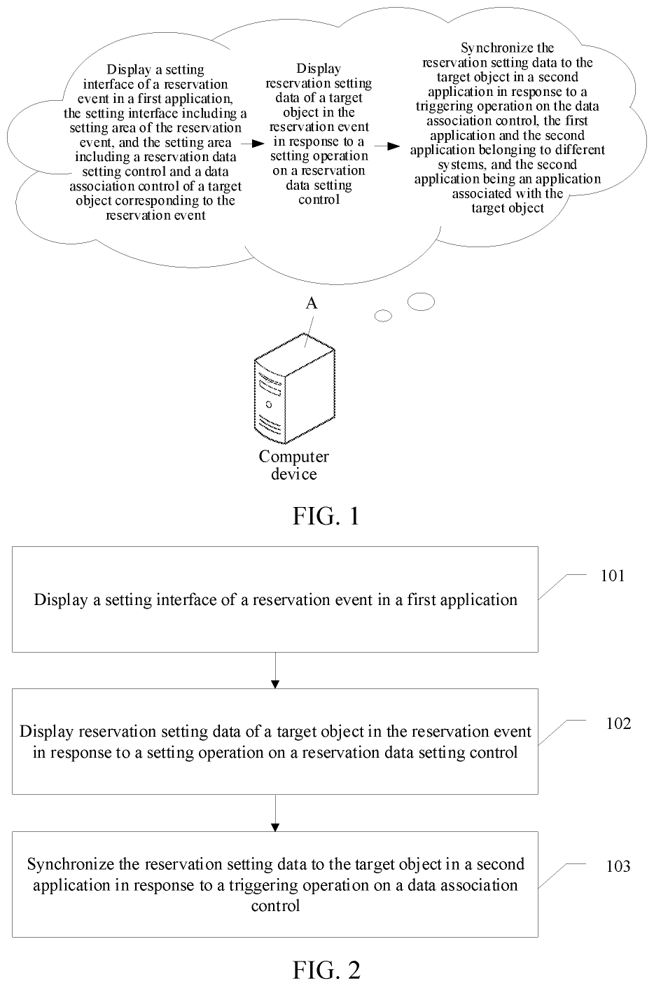

FIG. 1 is a schematic diagram of an exemplary scene of a data processing method according to this disclosure. As shown in FIG. 1, a computer device A displays a setting interface of a reservation event in a first application, the setting interface including a setting area of the reservation event, and the setting area including a reservation data setting control and a data association control of a target object corresponding to the reservation event. The computer device A displays reservation setting data of the target object in the reservation event in response to a setting operation on the reservation data setting control. The computer device A synchronizes the reservation setting data to the target object in a second application in response to a triggering operation on the data association control, the first application and the second application belonging to different systems, and the second application being an application associated with the target object.

The schematic diagram of the data processing scene shown in FIG. 1 is merely an example, and the data processing scene described in the embodiments of this disclosure is intended to illustrate the technical solution of this application more clearly and does not constitute a limitation on the technical solution provided by this disclosure. It can be seen by a person skilled in the art that, with the evolution of the data processing scene and the appearance of a new service scene, the technical solution provided by this disclosure is also applicable to similar technical problems.

Based on the above-mentioned implementation scene, each of them is described in detail below.

In the related art, when adopting electronic office, to make business functions of office applications more refined and specialized, different office applications often correspond to different sub-business functions. Furthermore, data between different applications is now independent from each other, and each application needs to be operated separately when updating the application data. Thus, when there is a certain association relationship between a plurality of applications and basic data needing to be updated is the same, each application still needs to be adjusted separately, thereby reducing the efficiency of data processing, and decreasing the office efficiency. For example, after a scheduled conference setting is performed on an online office application, the scheduled conference can only perform a calendar memorandum and reminding, but cannot realize an online conference function, and thus an additional setting needs to be performed on the online conference application to realize the online conference function. Conference data of the scheduled conference and the online conference are the same, and in this case, the same data needs to be set twice, and the data processing is inefficient. In this regard, this disclosure provides a data processing method for improving the efficiency of data processing between associated applications.

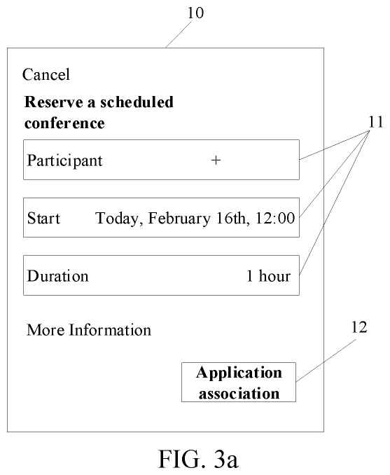

Embodiments of this disclosure will be described in terms of the data processing apparatus that may be integrated in the computer device. The computer device may be the terminal. The terminal may be a mobile phone, a tablet computer, a notebook computer, a smart television, a wearable intelligent device, a personal computer (PC), a vehicle-mounted terminal, and other devices. FIG. 2 is a flow schematic diagram of a data processing method according to this disclosure, and the method may include the following steps.

Step 101: Display the setting interface of the reservation event in the first application. In an example, an event setting interface of an event is displayed in a first application. The event setting interface includes an event data setting element and a data association control element of the event.

In embodiments of this disclosure, the first application may be any application program that may perform parameter input and setting processing. Here, the first application is configured to distinguish from a second application or a third application, etc. in this disclosure, and does not constitute a limitation on this disclosure itself. For example, the first application may be any one of an instant messaging application, a gaming application, an online office application, or an online conference application. In embodiments of this disclosure, taking the first application as the online office application as an example, the solution of this disclosure is described in detail.

The online office application may process reservation events of various functional applications, and the reservation events here may include scheduled events, conference events, or activity events, etc. When event reservation is required, the setting interface of the reservation event may be displayed in a display screen of the data processing apparatus. The setting interface of the reservation event may include the setting area of the reservation event, and the setting area includes the reservation data setting control and the data association control of the target object corresponding to the reservation event. The target object may be a conference needing to be reserved, and then the reservation data setting control of the target object may be a control configured to set the reservation setting data such as a reservation time, a reservation duration, a reservation location, and reservation participants of the conference.

Furthermore, the data association control may also be displayed in the setting area, and by touching the data association control, an association state corresponding to the data association control, namely, an on or off state, may be switched. When the association state corresponding to the data association control is in the off state, reservation setting data corresponding to a setting operation received on the setting interface is not associated with other applications; when the association state corresponding to the data association control is in the on state, the reservation setting data corresponding to the setting operation received on the setting interface is associated with an associated application. Alternatively, in some embodiments, the data association control does not have a plurality of states, and when touching the application association control, data association is performed, otherwise data association is not performed.

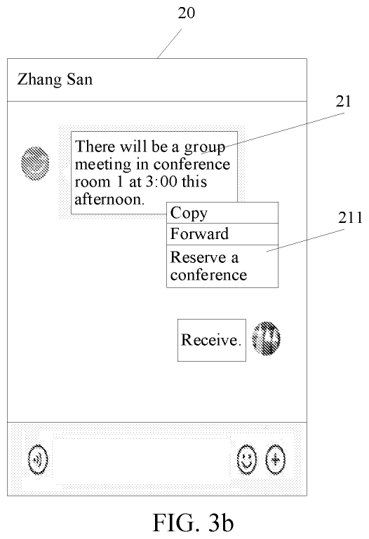

FIG. 3a is a schematic diagram of a setting interface of a reservation event of a first application according to this disclosure. As shown in FIG. 3a, in a setting interface 10, a plurality of reservation data setting controls 11 and an application association control 12 are included. In the setting interface 10, reservation setting data of the scheduled conference may be set through the reservation data setting control 11, and after the setting is completed, data storage and association may be performed by touching the application association control 12.

The computer device displays the setting interface of the reservation event of the first application. In an example, the computer device displays the setting interface of the reservation event of the first application in response to a touch control operation on a control indicating to enter the setting interface. Alternatively, the computer device displays the setting interface of the reservation event of the first application in response to other preset terminal operations. When displaying a home page of the first application, the computer device may switch the setting interface displaying the reservation event of the first application in response to a continuous tapping action on the home page displaying the first application. Alternatively, when displaying the home page of the first application, the computer device switches the setting interface displaying the reservation event of the first application in response to a voice instruction to switch to the setting interface displaying the reservation event. Thus, a preset computer device such as a terminal operation or inputting voice information may quickly switch to the setting interface displaying the reservation event of the first application, and when the setting interface of the reservation event is an operation interface corresponding to a function which needs to be frequently used, the search time of the setting interface of the reservation event may be reduced, thereby improving the interaction efficiency, saving computer resources, improving office efficiency, and improving a user's use experience.

In some embodiments, displaying the setting interface of the reservation event in the first application, the setting interface including the setting area of the reservation event, and the setting area including the reservation data setting control and the data association control of the target object corresponding to the reservation event includes: displaying a session interface in the first application; displaying a reservation event setting control in response to a selection operation on target session content in the session interface; and displaying the setting interface of the reservation event based on the target session content in response to a triggering operation on the reservation event setting control, the setting interface including the setting area of the reservation event, and the setting area including the reservation data setting control and the data association control of the target object corresponding to the reservation event.

In embodiments of this disclosure, in the first application, the setting interface of the reservation event may be directly jumped by the session interface of the first application. FIG. 3b includes a session interface 20 of the first application according to this disclosure. Session content between users of the first application is displayed in the session interface 20, which may be a group chat session interface or a private chat session interface. The computer device may display a function control corresponding to target session content 21 in response to a selection operation on the target session content 21 in the session interface 20, where the function control includes the reservation event setting control, namely, a reservation conference control 211. In embodiments of this disclosure, the computer device, in response to a dependent condition or state used to represent the operation to be performed, performs a corresponding operation when the dependent condition or state is satisfied, and one or more operations to be performed may be in real time or may have a set delay; without being specifically stated, there is no limitation in the order of execution of the plurality of operations to be performed. The selection operation on the target session content 21 in the session interface 20 may specifically be at least one of a long-press operation, a click operation, a slide operation, and a double-click operation on the target session content 21. The computer device may switch to display a conference setting interface, namely, the setting interface displaying the reservation event, based on the target session content in response to a touch operation on the reservation conference control 211.

The computer device may switch to display the conference setting interface based on the target session content. In an example, the computer device may perform content recognition on the target session content and extract conference setting information from the target session content, where the conference setting information is that, for example, conference time is 3:00 p.m. today, a conference place is conference room 1, and participants are members of this group. The computer device may then update the display of the conference data in the conference setting interface based on the extracted conference setting information.

In the embodiment, by adding a function control set by the reservation event to the session content in the session interface, it is possible to quickly switch to the setting interface of the reservation event directly according to the selected session content, without separately opening the setting interface of the reservation event. In addition, in the embodiment, the reservation setting data of the reservation event may also be updated according to the session content so that an operation of setting the reservation setting data of the reservation event may be reduced, thereby improving the setting efficiency of the reservation event.

In some embodiments, displaying the setting interface of the reservation event based on the target session content in response to the triggering operation on the reservation event setting control, the setting interface including the setting area of the reservation event, and the setting area including the reservation data setting control and the data association control of the target object corresponding to the reservation event includes performing voice recognition on voice information to obtain a recognition result in a case that the target session content is the voice information in response to the triggering operation on the reservation event setting control; extracting reservation setting data from the recognition result; and displaying the setting interface of the reservation event and updating the setting interface based on the reservation setting data, the setting interface including the setting area of the reservation event, and the setting area including the reservation data setting control and the data association control of the target object corresponding to the reservation event.

In embodiments of this disclosure, to improve communication efficiency, voice information is often used for a conversation in many scenes. For example, when the amount of information to be conveyed is large, typing will increase the difficulty of inputting the session content, and it is time-consuming to read, and adopting voice information to conduct a session can improve the efficiency of the session. In the scene, the data processing method provided by the embodiment may automatically perform voice recognition on the voice information in the target session content to obtain the recognition result of the voice recognition.

The computer device may also extract the reservation setting data, such as the aforementioned conference setting information, from the recognition result, and generate the setting interface of the corresponding reservation event using the reservation setting data. In the setting interface of the reservation event, corresponding data has been updated adopting the aforementioned extracted reservation setting data.

In the embodiment, the computer device recognizes a content form of the target session content, and when the target session content is session content in a voice form, extracts the reservation setting data in the target session content through the voice recognition, and updates the reservation setting data accordingly when switching the setting interface displaying the reservation event. An applicable scene of the data processing method provided by this disclosure is thus expanded so that the user may perform reservation event setting through the voice information, thereby improving the data setting efficiency of the reservation event.

In some embodiments, displaying the setting interface of the reservation event in the first application, the setting interface including the setting area of the reservation event, and the setting area including the reservation data setting control and the data association control of the target object corresponding to the reservation event includes displaying a calendar interface of the first application, the calendar interface including a plurality of date controls; and displaying the setting interface of the reservation event in response to a triggering operation on a target date control in the calendar interface, the setting interface including the setting area of the reservation event, the setting area including the reservation data setting control and the data association control of the target object corresponding to the reservation event, and the setting interface of the reservation event corresponding to a target date displayed in the target date control.

In embodiments of this disclosure, the first application may include a calendar function, and the computer device may, in response to an operation of selecting any date in the calendar interface, newly create a reservation event corresponding to the date. That is, the computer device may switch to the setting interface displaying the reservation event in response to the triggering operation on the target date control in the calendar interface.

In the embodiment, in an office scene, it is often necessary to view a calendar to confirm the itinerary, thereby facilitating itinerary planning. By setting a control corresponding to a target date in a calendar interface for viewing a calendar to switch to the setting interface of the reservation event directly, a reservation event may be created without exiting the calendar interface, thereby improving the setting efficiency of the reservation event.

Step 102: Display the reservation setting data of the target object in the reservation event in response to the setting operation on the reservation data setting control. In an example, event setting data of the event is received from a user via the event data setting element.

In the setting interface of the reservation event, the computer device may set the reservation setting data of the target object in the reservation event in response to the setting operation on the reservation data setting control. For example, the computer device displays a reservation setting data selection interface or displays a reservation setting data input interface in response to a touch operation on the reservation setting control, determines reservation setting data selected in the reservation setting data selection interface, or determines reservation setting data inputted in the reservation setting data input interface, and obtains the reservation setting data of the target object in the reservation event.

When the target object is the scheduled conference in the online office application, the computer device may display a selection interface of conference participants, conference time, or a conference place in response to a triggering operation on the reservation data setting control, and the selection interface is used for providing a function of selecting corresponding conference participants, conference time, and conference place. Alternatively, the computer device displays a conference theme input interface in response to the triggering operation on the reservation data setting control, and the conference theme input interface is used for providing a function of inputting a conference theme.

After determining that the reservation setting data is set, the computer device may display the set reservation setting data to check and verify the reservation setting data. In some cases, when the reservation setting data is large, the computer device may display only a portion of the reservation setting data. For example, when there are a large number of participants, the computer device may display only a portion of participant information.

Step 103: Synchronize the reservation setting data to the target object in the second application in response to the triggering operation on the data association control. In an example, the event setting data of the event is sent to a second application based on a user selection of the data association control element. The first application is associated with a first service and the second application is associated with a second service that is different from the first service.

In the related art, performing parameter setting on the setting interface of the reservation event of the first application can only process and update data in the first application. Since data between applications are independent from each other, if application data of other second applications except the first application needs to be updated, a corresponding parameter setting operation needs to be performed on a respective operation interface of the second application. This requires additional time and effort to process, resulting in inefficient data processing. However, in the data processing solution provided by this disclosure, a parameter setting is performed on the setting interface of the reservation event of the first application, and the reservation setting data set in the first application may be synchronized to the second application associated with the target object corresponding to the reservation setting data so as to update the data of the second application. The first application and the second application belong to different systems, namely, systems corresponding to the two are independent from each other.

In some embodiments of this disclosure, the computer device may update the respective data of the second application in real time in response to the setting operation received through the setting interface of the reservation event, and may also update the application data of the second application according to the setting operation received in the setting area in response to a data association operation. The data association operation may be a touch operation on the data association control, may also be a preset gesture control operation on a terminal corresponding to the data processing apparatus, and may also be receiving a preset voice instruction, etc. In some embodiments of this disclosure, the computer device may synchronize the reservation setting data to the target object in the second application in response to the triggering operation on the data association control.

In some embodiments, synchronizing the reservation setting data to the target object in the second application in response to the triggering operation on the data association control, the first application and the second application belonging to different systems, and the second application being the application associated with the target object includes displaying an associated application candidate list in response to the triggering operation on the data association control; and synchronizing the reservation setting data to the target object in a target associated application in response to a selection operation on the target associated application in the associated application candidate list, the target associated application and the first application belonging to different systems, and the target associated application being the application associated with the target object.

In embodiments of this disclosure, the second application is the target associated application. The target associated application is any application in the associated application candidate list. The first application may be associated with one or more applications, more meaning at least two. The computer device may determine a second application associated with the first application based on the selection operation in the presented associated application candidate list. For example, the computer device may display the associated application candidate list in response to the triggering operation on the data association control. Each application in the associated application candidate list may be an application associated with the aforementioned target object. When the target object is the scheduled conference, the applications in the associated application candidate list may be applications explicitly associated with the conference, such as the online conference application, a conference management application, or a conference site management application. Furthermore, each application in the associated application candidate list may also be an application belonging to a different system from the first application.

The computer device may synchronize the aforementioned reservation setting data to the target object in the target associated application in response to the selection operation on the target associated application in the associated application candidate list.

FIG. 3c includes an exemplary associated application selection interface according to this disclosure. In the embodiment, the computer device may display an associated application selection interface 30 in response to the touch operation on the data association control and display candidate associated application controls 31 corresponding to a plurality of candidate associated applications on the associated application selection interface 30.

The computer device may determine that the target associated application is a second application associated with the target object of the first application in response to a selection operation on the candidate associated application control of the target associated application in the associated application candidate list, and synchronize the reservation setting data to the target associated application, namely, the target object in the second application.

In embodiments of this disclosure, by setting the associated application candidate list, the user may select a second application needing to perform data synchronization by himself so that the flexibility of data synchronization may be improved. In addition, in the embodiment, the data setting for the first application may perform data synchronization for a plurality of applications so that the efficiency of data processing may be further improved.

In some embodiments, displaying the associated application candidate list in response to the triggering operation on the data association control includes displaying a login verification interface in response to the triggering operation on the data association control, the first application logging in a first account; acquiring an inputted second account and first verification information of the second account in response to an information input operation on the login verification interface; and displaying an associated application candidate list corresponding to the second account in a case that the first verification information is verified, the first account and the second account being accounts in a system corresponding to the first application.

In embodiments of this disclosure, the candidate associated application contained in the associated application candidate list may be determined according to information of the first account logging in the current first application, and may also be determined according to other account information. Here, the first account and the second account are both accounts in the first system corresponding to the first application, namely, the first account and the second account are both accounts registered in a server corresponding to the first application.

The computer device may display the login verification interface in response to the triggering operation on the data association control, and display an account input area and a verification information input area on the login verification interface. The account input area is used for inputting account information that needs to perform data synchronization, and the verification information input area is used for inputting verification information corresponding to the account information. When an account currently logged in by the first application includes the first account number, an account inputted in the account input area may be the second account number. It is to be understood that the first account and the second account are different accounts in the first system. Thus, when the verification information corresponding to the second account is verified, the computer device may display the associated application candidate list corresponding to the second account.

FIG. 3d includes an exemplary login verification interface according to this disclosure. As shown in FIG. 3d, in a login verification interface 40, a verification information input area 41 is included. The verification information input area 41 is used for inputting respective account information and password to determine a second account of an application needing to be associated. The second account may correspond to a plurality of associated applications that may be displayed in a list for selection.

In embodiments of this disclosure, by displaying a login verification interface corresponding to an account needing to perform data synchronization during data synchronization, application data synchronization across accounts may be realized without switching a login account of the first application. Thus, in a team collaborative office scene, the efficiency of data processing may be improved, and then the efficiency of the team collaborative office may be improved.

In some embodiments, acquiring an inputted second account and first verification information of the second account in response to an information input operation on the login verification interface includes displaying an account selection control in the login verification interface; displaying an address book list corresponding to the first account in response to a triggering operation on the account selection control; transmitting a verification information acquisition request to a target messaging object in response to a selection operation on the target messaging object in the address book list; and receiving a second account and the first verification information of the second account returned by the device of the target messaging object according to the verification information acquisition request.

In embodiments of this disclosure, when data synchronization across accounts is performed, account information and verification information of the second account may not need to be manually inputted but may be directly acquired by transmitting the verification information acquisition request to a user corresponding to the second account.

In an example, when the first application is the online office application, to improve the efficiency of online office, the online office application may also provide a certain communication function, for example an instant messaging function. Then, for each account, there may be an address book corresponding thereto, and the address book may be a friend address book or an enterprise address book. Thus, in the embodiment, the login verification interface may also have the account selection control, and the computer device may display the address book list corresponding to the first account currently logged in to the first application in response to the touch operation on the account selection control. The computer device may then transmit the verification information acquisition request to a device of the target messaging object in response to the selection operation on the target messaging object in the address book list. After receiving the verification information acquisition request, the device of the target messaging object may return the second account and the verification information corresponding to the second account through an authorization operation.

By transmitting the verification information acquisition request to a device of a target messaging object corresponding to a second account which needs to perform cross-account data synchronization, embodiments of this disclosure may directly acquire the second account and the verification information corresponding to the second account. Thus, it is not necessary to manually input the second account and the verification information corresponding thereto so that the verification efficiency of the second account may be improved, and the efficiency of data processing may be improved.

In some embodiments, transmitting the verification information acquisition request to the target messaging object in response to the selection operation on the target messaging object in the address book list includes: displaying a dialog box with the target messaging object in response to the selection operation on the target messaging object in the address book list; and transmitting a verification information acquisition link to the target messaging object in the dialog box, the verification information acquisition link including the verification information acquisition request.

In embodiments of this disclosure, the computer device may transmit the verification information acquisition request to the device of the target messaging object by an instant messaging dialogue. For example, the computer device may first generate the verification information acquisition link according to the verification information acquisition request, then open the dialog box with the target messaging object, and transmit the verification information acquisition link to the device of the target messaging object in the dialog box. At this time, the device of the target messaging object may display the instant messaging message in the first application client and may display the dialog box in response to a triggering operation, such as a click operation, on the instant messaging message and display the verification information acquisition link in the dialog box. The device of the target messaging object may authorize transmitting the second account and the verification information of the second account to the first application client logging in to the first account in response to a triggering operation, such as a click operation, on the verification information acquisition link.

In the embodiment, the instant messaging function of the first application and a data synchronization function are combined to remotely acquire the second account which needs to perform cross-account data synchronization so that the efficiency of acquiring the second account and the verification information thereof may be improved, and the efficiency of data processing may be improved. In addition, the method may also present the verification information acquisition request to the target messaging object and provide an authorized use channel of the account and the verification information, thereby ensuring the security of the account and the data.

In some embodiments, synchronizing the reservation setting data to the target object in the second application in response to the triggering operation on the data association control, the first application and the second application belonging to different systems, and the second application being the application associated with the target object includes determining a plurality of participants participating in the reservation event according to the reservation setting data in response to the triggering operation on the data association control; and synchronizing the reservation setting data to the target object corresponding to each of the participants in the second application, the first application and the second application belonging to different systems, and the second application being the application associated with the target object.

In embodiments of this disclosure, when the first application is the online office application, the second application is the online conference application, and the target object is the conference; when a plurality of participants are determined to participate in the reservation event based on the reservation setting data of the reservation event, namely, there are a plurality of conference participants, and when cross-application data synchronization is performed, cross-application data synchronization may be performed simultaneously on a target object corresponding to each participant participating in the conference.

In an example, the computer device, in response to the triggering operation on the data association control, acquires personnel information of a plurality of participants participating in the reservation event from the reservation setting data, i.e., determining the plurality of participants participating in the reservation event. The computer device may then synchronize the reservation setting data to the target object corresponding to each of the participants in the second application.

In some embodiments, the computer device may further acquire organizational structure information of the enterprise address book in the first application after acquiring the personnel information of each of the participants participating in the reservation event. The computer device may then determine an organizational relationship between the personnel information of the person participating in the reservation event and personnel information corresponding to the first account currently logged in to the first application based on the organizational structure information. When the organizational relationship satisfies a preset condition, for example, when a person corresponding to the first account is a supervisor of other persons participating in the reservation event, the computer device determines that the first account has a right to synchronize the reservation setting data into the target object corresponding to each participant of the reservation event in the second application. Then, the computer device further synchronizes the reservation setting data to the target object corresponding to each of the participants in the second application.

In embodiments of this disclosure, the computer device may further perform one-to-many cross-account and cross-application data synchronization based on information of the participant participating in the reservation event. That is, when the computer device may set the data of the first account in the first application, the setting data may be synchronized into a plurality of accounts of the second application, thereby improving the efficiency of data processing.

In some embodiments, synchronizing the reservation setting data to the target object in the second application in response to the triggering operation on the data association control, the first application and the second application belonging to different systems, and the second application being the application associated with the target object includes displaying an application association authorization interface in response to a triggering operation on an application association control; and synchronizing the reservation setting data to the target object in the second application in response to a confirmation authorization operation received by the application association authorization interface, the first application and the second application belonging to different systems, and the second application being the application associated with the target object.

In embodiments of this disclosure, the computer device may acquire application association authorization of the user before synchronizing the reservation setting data to the target object in the second application. Since the first application and the second application are applications of different systems, in the same system, different accounts have data modification rights corresponding to different accounts. While in different systems, the same account does not exist; that is, no account in the first application has a right to modify the data in the second application. In order to modify the data in the second application to synchronize the reservation setting data into the target object of the second application, a third account capable of modifying the data of the second application and verification information thereof need to be acquired first. Here, the third account is an account in the second system corresponding to the second application, and the third account is an account corresponding to the first account in the first system, for example, the first account and the third account are accounts of the same user.

Therefore, in order to ensure data security, the computer device may display the application association authorization interface for the user to authorize the use of the third account and the verification information thereof in response to the triggering operation on the application association control. The computer device may then acquire the third account and the verification information thereof in response to the confirmation authorization operation received by the application association authorization interface and synchronize the reservation setting data to the target object corresponding to the third account in the second application.

In embodiments of this disclosure, a user performs application association authorization by displaying the association authorization interface to synchronize data of the second application based on the user authorization so that the security of data processing may be ensured.

In some embodiments, synchronizing the reservation setting data to the target object in the second application in response to the confirmation authorization operation received by the application association authorization interface, the first application and the second application belonging to different systems, and the second application being the application associated with the target object includes acquiring the third account and the second verification information corresponding to the third account in response to the confirmation authorization operation received by the application association authorization interface, the first application belonging to the first system, the third account being the account of the second application in the second system, and the second application being the application associated with the target object; and transmitting the reservation setting data, the third account, and the second verification information to the second application to make the second application perform data synchronization on the target object corresponding to the third account according to the reservation setting data.

Here, the third account in the second application is an account associated with the first account in the first application. Here, the association relationship between the first account and the third account may specifically be that the two have the same form, for example, both are the same string. The computer device may acquire a third account authorized for use and the verification information corresponding to the third account in response to the confirmation authorization operation received by the application association authorization interface.

The computer device may then transmit the aforementioned reservation setting data, the third account, and the verification information corresponding to the third account to the second application in the second system to make the second application perform data synchronization on the target object corresponding to the third account according to the reservation setting data.

According to the above-mentioned description, it can be seen that embodiments of this disclosure provide a data processing method, including: displaying the setting interface of the reservation event in the first application, the setting interface including the setting area of the reservation event, and the setting area including the reservation data setting control and the data association control of the target object corresponding to the reservation event; displaying the reservation setting data of the target object in the reservation event in response to the setting operation on the reservation data setting control; and synchronizing the reservation setting data to the target object in the second application in response to the triggering operation on the data association control, the first application and the second application belonging to different systems, and the second application being the application associated with the target object.

Thus, the data processing method provided by this disclosure may synchronize data corresponding to an associated application program when processing data of one application program by performing data association between independent application programs. Thus, the data processing efficiency between different applications associated with each other may be improved.

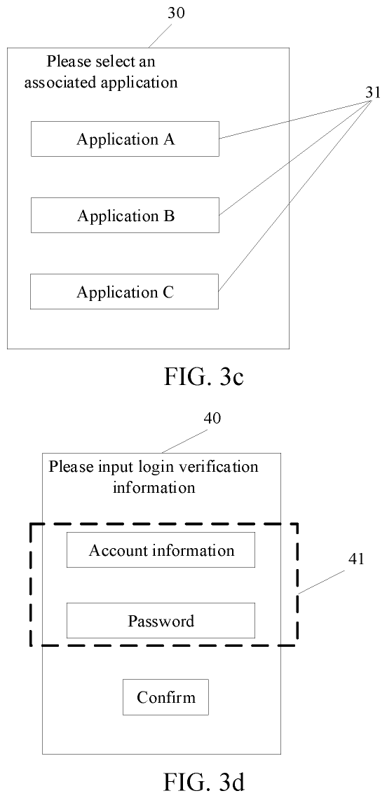

This disclosure also provides a data processing method that may be used in the computer device, and the computer device may be the terminal. As shown in FIG. 4, it is another flow schematic diagram of a data processing method according to this disclosure, and the method may include the following steps.

Step 201: The computer device receives a conference creation instruction of the online office application and displays a conference creation interface of the online office application.

In embodiments of this disclosure, the data processing apparatus being the computer device is specifically described in detail. Furthermore, the computer device may particularly be a terminal having a display screen and capable of data interaction. Furthermore, taking the first application being the online office application and the second application being the online conference application as an example, the data processing method provided by this disclosure is described in further detail. The online office application may be an Internet-based office application, relative to offline office, it provides more convenient communication channels and more professional office management, which may improve office efficiency. The online office application has a function of creating a new conference and conference reservation, and the conference reserved in the online office application may be either an offline conference or an online conference. The online conference application provides the function of the online conference so that people in different geographic locations may realize face-to-face communication through the Internet.

According to the above-mentioned introduction, it can be seen that the online office application and the online conference application provide application functions with different emphases, and the online office application may provide full-scale office cooperation, and creating a new conference and the conference reservation are only one module therein. The online conference application only provides the function of the online conference and may provide the platform construction of a real conference scene and data transmission. The conference function provided by the online conference application is more comprehensive and professional and may provide a better online conference experience. In addition, the new conference in the online office application may be synchronized with schedule information, and the schedule information may provide functions such as schedule management and event reminding. That is, a single application cannot meet all the functional requirements of the user, and the same basic data exists between different applications. In this scene, the data processing method provided by this disclosure may be used to improve the efficiency of data processing.

In some embodiments of this disclosure, when conference creation is performed on the computer device using the online office application, the computer device may receive the conference creation instruction in the online office application and display the conference creation interface of the online office application in the display screen of the computer device. The conference created here may be the scheduled conference, and information such as participants, conference time, conference duration, and conference place may be set in the conference creation interface.

Step 202: The computer device acquires a conference parameter setting operation received by the conference creation interface and generates conference data according to the conference parameter setting operation.

After the conference creation interface is displayed on a display interface of the computer device, the conference parameter setting operation inputted by a conference creator on the conference creation interface may be received. The conference parameter setting operation may be either selecting a conference parameter or inputting a respective conference parameter. In an example, a respective participant may be selected from an address book provided by the online office application; conference start time may be selected from a preset time list; the conference duration may be selected from a preset duration list; and a respective conference theme may be inputted in a conference theme input area.

When the conference creator performs the conference parameter setting operation on the conference creation interface, the computer device may acquire the conference parameter setting operation received by the conference creation interface in real time and generate conference data according to the acquired conference parameter setting operation.

Step 203: The computer device updates conference information in the online office application according to the conference data.

After generating the conference data according to the conference parameter setting operation received on the conference creation interface, the computer device may update the conference information in the online office application according to the conference data. The conference information may be scheduled conference information, namely, schedule data in the online office application may also be updated while the conference data in the online office application is updated.

In some embodiments, the computer device updates the conference information in the online office application according to the conference data, and may specifically include the following.

The computer device acquires account information of a current login online office application.

The computer device transmits the account information and the conference data to an online office server so that the online office server updates conference information corresponding to the account information in the online office server.

It is to be understood that the data of the online office application is managed by the online office server, and when the data of the online application is updated, respective data needs to be transmitted to the online application server and updated by the online application server. The online office server may be an independent physical server, may also be a server cluster or distributed system including a plurality of physical servers, and may also be a cloud server providing basic cloud computing services, such as a cloud service, a cloud database, cloud computing, a cloud function, cloud storage, a network service, cloud communication, a middleware service, a domain name service, a security service, a content delivery network (CDN), and a large data and artificial intelligence platform. The server may be a node in the blockchain. Therefore, in embodiments of this disclosure, after generating the conference data according to the conference parameter setting operation received on the conference creation interface, the computer device may further acquire account information about logging in a current online office application client. Because the online application server manages the online office data on an account-by-account basis, data corresponding to different accounts are independent from each other in the online office server, and the online office server updates the online application data on an account-by-account basis separately.

After acquiring the account information of the current login online office application client, the computer device transmits the account information of the current login online office application client together with the aforementioned generated conference data to the online office server. The online office server updates conference information corresponding to the account information according to the received account information and the conference data.

Step 204: The computer device determines a target server corresponding to the online conference application associated with the online office application in response to a conference data association operation.

In the data processing method provided by this disclosure, while updating the conference information of the online application according to a new conference operation of the online office application received in the computer device, relevant data of the online conference application associated with the online office application may also be synchronously updated to realize data synchronous update of different applications having an association relationship.

In an example, the data of the online conference application associated with the online office application may be updated in response to the conference data association operation. The conference data association operation may be a touch operation on an application data association control displayed in the conference creation interface of the online office application and may also be voice information indicating application data association inputted by a conference creator. A specific form of the conference data association operation is not limited herein, so long as the operation contains an instruction to associate the conference data to the online conference application. In another case, the current flow may be terminated if the computer device does not receive the instruction to associate the conference data to the online conference application.

Likewise, it is also the online conference server that manages the data of the online conference application. It also needs to be realized through the online conference server to update the conference data in the online conference application. Therefore, in some embodiments of this disclosure, after receiving the instruction to associate the conference data to the online conference application, the computer device needs to first acquire server information of the online conference server, namely, determining the target server corresponding to the online conference application. For example, server address information of the online conference server may be acquired.

Step 205: The computer device acquires online conference application account information needed to perform conference data association.

Since the online conference server manages the data of the online conference application according to accounts. The conference data in the online conference server needs to be adjusted, and account information of an online conference application to be adjusted needs to be determined first. Therefore, after acquiring the server information of the online conference server, online conference application account information needed to perform the conference data update needs to be further determined.

Online conference application account information to be updated with the conference data may be account information associated with online office application account information, or account information not associated with the online office application account information.

When the online conference application account information to be updated with the conference data is the account information associated with the online office application account information, the online conference application account information to be updated with the conference data may be determined according to the account information of the online office application client currently logged on the computer device. For example, key data such as account name data, number data, or mailbox data may be acquired from the account information of the online office application client currently logged on the computer device. Furthermore, in order to acquire a modification right of data corresponding to a certain account in the online conference server, in addition to acquiring account information thereof, verification information data corresponding to the account needs to be further acquired, and the verification information may be password data. In the embodiment, an associated application account management function may be provided for the online office application for managing an account of the associated application of the online office application. When one target online office account is adopted to log in the online office application client, the client may be opened to acquire account information of an online conference application account associated with the target online office account and a right of verification information data corresponding thereto. When there are other applications associated with the online office application, the online office client may also be correspondingly opened to acquire account information of accounts of other associated applications and the right of verification information data.

When the online conference application account information to be updated with the conference data is the account information not associated with the online office application account information, after receiving the instruction to associate the conference data to the online conference application, a login verification information input interface may be further displayed in the display screen of the computer device for the conference creator to input respective account information and corresponding password data. Then, the account information and corresponding password data received by the login verification information interface are determined as the online conference application account information needed to perform conference data association.

Step 206: The computer device transmits the conference data, the online conference application account information, and a conference data update instruction to the target server to cause the target server to update conference information in the online conference application account information.

After determining server information of the target server corresponding to the online conference application and the online conference application account information needed to perform conference data association, the computer device may transmit the online conference application account information, the conference data update instruction, and the aforementioned generated conference data to the target server. The target server is the online conference server, and after receiving the conference data update instruction, the online conference application account information, and the conference data, the online conference server may update data corresponding to the online conference application account according to the conference data to update data responding to the online conference application.

In some embodiments, the computer device transmits the conference data, the online conference application account information, and the conference data update instruction to the target server, which may specifically be that the computer device first transmits the conference data, the online conference application account information, and the conference data update instruction to the online office server through the online office application client, and then the online office application server forwards the conference data, the online conference application account information, and the conference data update instruction to the online conference server so that the online conference server updates data according to the received relevant data.

It is to be understood that this disclosure merely introduces the data processing method provided by this disclosure by taking an example of displaying the conference creation interface in the display screen of the computer device. In some other embodiments, it may also be displaying an operation interface that changes the conference information such as conference information modification and conference deletion in the display screen of the computer device, and a specific data flow thereof may refer to the aforementioned corresponding flow for creating the conference.

In some embodiments, it may also be displaying the conference operation interface of the online conference application in the display screen of the computer device, where the conference operation may be any one of a meeting creation, a meeting modification, or a meeting deletion. The application data in the online conference is then synchronously updated according to an operator's operation of the online conference application. The specific data processing flow is consistent with the data processing flow provided in FIG. 4.

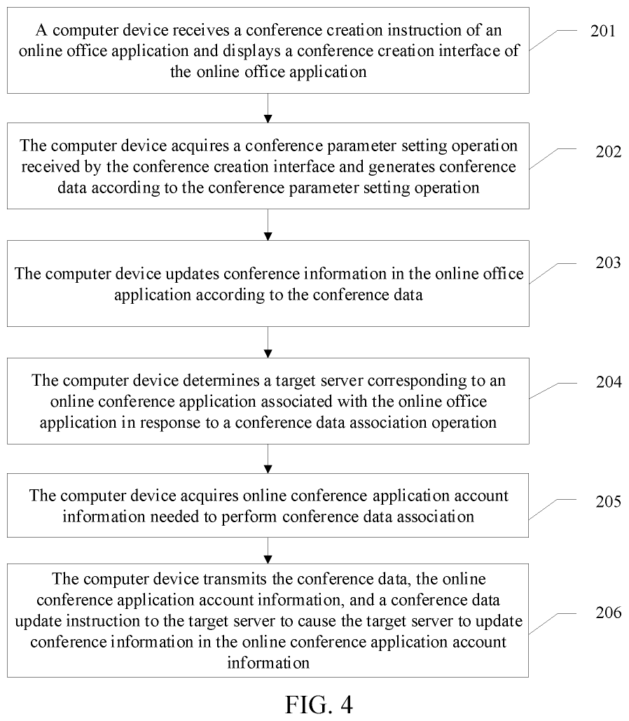

FIG. 5 illustrates an exemplary interaction timing diagram of a data processing method according to this disclosure. As shown in FIG. 5, in embodiments of this disclosure, the computer device may display a conference operation interface of the online office application, receive a conference setting operation, and then transmit a received conference setting operation to the online office server through the online office application client on the computer device. The conference setting operation may include, but is not limited to, creating a new conference, modifying the conference content, and deleting the conference. Modifying the conference content may be modifying the conference time, conference duration, conference theme, or conference participant, etc. After receiving the conference setting operation, the online office server generates the conference data according to the conference setting operation. Furthermore, the online office server determines the online office application account information according to account information logged in a client which transmits the conference setting operation to the online office server and then updates application data of the online office application corresponding to the online office application account according to the conference data. Further, the online office server acquires online conference server information, where the online conference server is a server corresponding to the online conference application associated with the online office application. The online office server may further acquire online conference account information, where the online conference account information is information corresponding to an online conference account needed to perform the data update according to conference data. The online office server then transmits the online conference account information and the conference data to the online conference server. After receiving the online conference account information and the conference data, the online conference server performs the data update on the online conference application corresponding to the online conference account information according to the conference data.

In another embodiment, the computer device may display a conference operation interface of the online conference application, receive the conference setting operation, and then transmit the received conference setting operation to the online conference server through an online conference application client on the computer device. The conference setting operation may include, but is not limited to, creating a new conference, modifying the conference content, and deleting the conference. Modifying the conference content may be modifying the conference time, conference duration, conference theme, or conference participant, etc. After receiving the conference setting operation, the online conference server generates the conference data according to the conference setting operation. Furthermore, the online conference server determines the online conference application account information according to account information logged in a client which transmits the conference setting operation to the online conference server and then updates application data of the online conference application corresponding to the online conference application account according to the conference data. Further, the online conference server acquires online office server information, where the online office server is a server corresponding to an online office application associated with the online conference application. The online conference server may further acquire online office account information, where the online office account information is information corresponding to an online office account needed to perform the data update according to conference data. The online conference server then transmits the online office account information and the conference data to the online office server. After receiving the online office account information and the conference data, the online office server performs the data update on the online office application corresponding to the online office account information according to the conference data.

According to the above-mentioned description, it can be seen that the data processing method provided by this disclosure includes: displaying a target operation interface of the first application, the target operation interface including a parameter setting area; updating the application data of the second application according to a setting operation received by the parameter setting area in response to an application data association operation, the second application being an application associated with the target operation interface of the first application.

Thus, the data processing method provided by this disclosure may update data corresponding to an associated application program when processing data of one application program by performing data association between independent application programs. Thus, the data processing efficiency between different applications associated with each other may be improved.

In order to better implement the above data processing method, embodiments of this disclosure also provide a data processing apparatus which may be integrated in the terminal or the server.

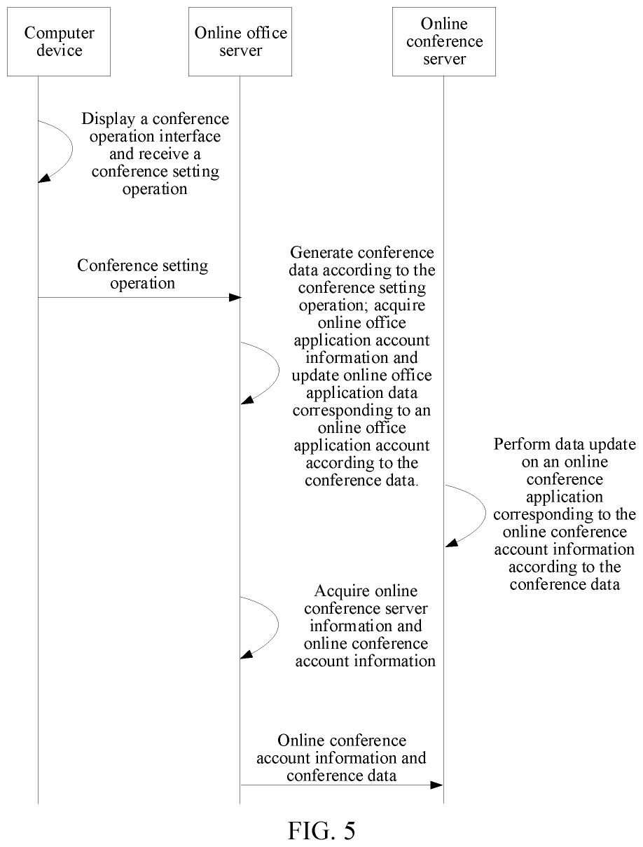

For example, as shown in FIG. 6, it is a schematic structural diagram of a data processing apparatus according to an embodiment of this disclosure. The data processing apparatus may include a first display unit 301, a second display unit 302, and a synchronization unit 303.

The first display unit 301 is configured to display the setting interface of the reservation event in the first application, the setting interface including the reservation data setting control and the data association control of the target object corresponding to the reservation event.

The second display unit 302 is configured to display the reservation setting data of the target object in the reservation event in response to the setting operation on the reservation data setting control.

The synchronization unit 303 is configured to synchronize the reservation setting data to the target object in the second application in response to the triggering operation on the data association control, the first application and the second application belonging to different systems, and the second application being the application associated with the target object.

In some embodiments, the synchronization unit includes a first display subunit and a first synchronization subunit.

The first display subunit is configured to display an associated application candidate list in response to the triggering operation on the data association control.

The first synchronization subunit is configured to synchronize the reservation setting data to the target object in the target associated application in response to the selection operation on the target associated application in the associated application candidate list, the target associated application and the first application belonging to different systems, the target associated application being the application associated with the target object, and the second application being the target associated application.

In some embodiments, a display subunit includes a first display module, an acquisition module, and a second display module.

The first display module is configured to display the login verification interface in response to the triggering operation on the data association control, the first application logging in the first account.

The acquisition module is configured to acquire the inputted second account and the first verification information of the second account in response to the information input operation on the login verification interface.

The second display module is configured to display the associated application candidate list corresponding to the second account in a case that the first verification information is verified, the first account and the second account being accounts in the system corresponding to the first application.

In some embodiments, the acquisition module includes a first display submodule, a second display submodule, a transmitting submodule, and a receiving submodule.

The first display submodule is configured to display the account selection control in the login verification interface.

The second display submodule is configured to display the address book list corresponding to the first account in response to the triggering operation on the account selection control.

The transmitting submodule is configured to transmit the verification information acquisition request to the device of the target messaging object in response to the selection operation on the target messaging object in the address book list.

The receiving submodule is configured to receive a second account and the first verification information of the second account returned by the device of the target messaging object according to the verification information acquisition request.

In some embodiments, the transmitting submodule is further configured to display the dialog box with the target messaging object in response to the selection operation on the target messaging object in the address book list; and transmit the verification information acquisition link to the device of the target messaging object in the dialog box, the verification information acquisition link including the verification information acquisition request.

In some embodiments, the synchronization unit includes a determination subunit and a second synchronization subunit.

The determination subunit is configured to determine a plurality of participants participating in the reservation event according to the reservation setting data in response to the triggering operation on the data association control.

The second synchronization subunit is configured to synchronize the reservation setting data to the target object corresponding to each of the participants in the second application.

In some embodiments, the first display subunit includes a second display subunit, a third display subunit, and a fourth display subunit.

The second display subunit is configured to display the session interface in the first application.

The third display subunit is configured to display the reservation event setting control in response to the selection operation on the target session content in the session interface.

The fourth display subunit is configured to display the setting interface of the reservation event based on the target session content in response to the triggering operation on the reservation event setting control.

In some embodiments, the fourth display subunit includes a recognition module, an extraction module, and a third display module.

The recognition module is configured to perform voice recognition on the voice information to obtain the recognition result in a case that the target session content is the voice information in response to the triggering operation on the reservation event setting control.

The extraction module is configured to extract the reservation setting data from the recognition result.

The third display module is configured to display the setting interface of the reservation event and update the setting interface based on the reservation setting data.

In some embodiments, the synchronization unit includes a fifth display subunit and a third synchronization subunit.

The fifth display subunit is configured to display the application association authorization interface in response to the triggering operation on an application association control.

The third synchronization subunit is configured to synchronize the reservation setting data to the target object in the second application in response to the confirmation authorization operation received by the application association authorization interface.

In some embodiments, the third synchronization subunit includes an acquisition module and a transmitting module.

The acquisition module is configured to acquire the third account and the second verification information corresponding to the third account in response to the confirmation authorization operation received by the application association authorization interface, the first application belonging to the first system, the third account being the account of the second application in the second system, and the second application being the application associated with the target object.

The transmitting module is configured to transmit the reservation setting data, the third account, and the second verification information to the second application to make the second application perform data synchronization on the target object corresponding to the third account according to the reservation setting data.

In some embodiments, the first display subunit includes a fifth display subunit and a sixth display subunit.

The fifth display subunit is configured to display the calendar interface of the first application, the calendar interface including a plurality of date controls.

The sixth display subunit is configured to display the setting interface of the reservation event in response to the triggering operation on the target date control in the calendar interface, the setting interface of the reservation event corresponding to the target date displayed in the target date control.

In an exemplary implementation, the above-mentioned units may be implemented as independent entities or in any combination and implemented as the same or several entities, and reference can be made to the above-mentioned method embodiments for the implementation of the above-mentioned units.

According to the above-mentioned description, it can be seen that embodiments of this disclosure include a data processing apparatus, including: the first display unit 301, configured to display the setting interface of the reservation event in the first application, the setting interface including the setting area of the reservation event, and the setting area including the reservation data setting control and the data association control of the target object corresponding to the reservation event; the second display unit 302, configured to display the reservation setting data of the target object in the reservation event in response to the setting operation on the reservation data setting control; and the synchronization unit 303, configured to synchronize the reservation setting data to the target object in the second application in response to the triggering operation on the data association control, the first application and the second application belonging to different systems, and the second application being the application associated with the target object.

Thus, the data processing method provided by this disclosure may synchronize data corresponding to an associated application program when processing data of one application program by performing data association between independent application programs. Thus, the data processing efficiency between different applications associated with each other may be improved.

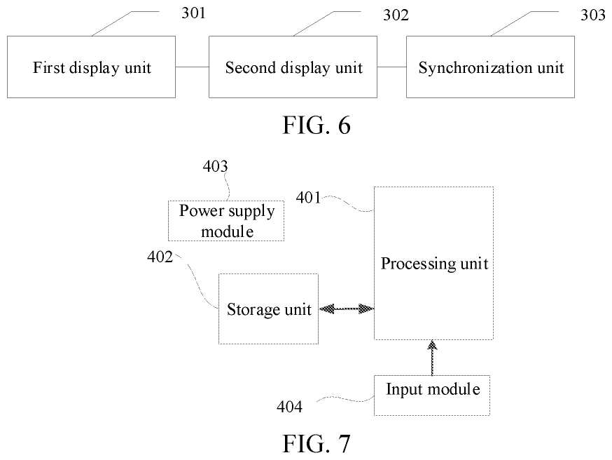

Embodiments of this disclosure also provide a computer device, which may be a terminal or a server. As shown in FIG. 7, it is a schematic structural diagram of a computer device according to an embodiment of this disclosure.

The computer device may include elements such as a processing unit 401 of one or more processing cores, a storage unit 402 of one or more storage media, a power supply module 403, and an input module 404. It will be appreciated by a person skilled in the art that the computer device structure shown in FIG. 7 does not constitute a limitation on the computer device and may include more or fewer elements than shown, a combination of some elements, or elements with different arrangements.

The processing unit 401, or processing circuitry, is a control center of the computer device, connecting various portions of the entire computer device with various interfaces and circuits, performing various functions of the computer device and processing the data by running or executing software programs and/or modules stored in the storage unit 402, and calling data stored in the storage unit 402. The processing unit 401 may include one or more processing cores. The processing unit 401 may integrate an application processor and a modem processor. The application processor (for example, processing circuitry) processes an operating system, a user interface, an application program, etc., and the modem processor (for example, communication circuitry) processes wireless communication. It is to be understood that the above-described modem processor may not be integrated into the processing unit 401.

The storage unit 402 may be configured to store software programs and modules, and the processing unit 401 executes the software programs and modules stored in the storage unit 402 to perform various functional applications and data processing. The storage unit 402 may mainly include a storage program area and a storage data area, where the storage program area may store the operating system, an application program required by at least one function (such as a sound playing function, an image playing function, and web page access), etc.; the storage data area may store data or the like created according to the use of the computer device. In addition, the storage unit 402 may include a high-speed random access memory and may also include a non-volatile memory, such as at least one magnetic disk storage component, flash memory component, or other volatile solid state storage component. Accordingly, the storage unit 402 may also include a memory controller to provide access to the storage unit 402 by the processing unit 401.

The computer device further includes the power supply module 403 configured to supply power to various elements. The power supply module 403 may be logically connected to the processing unit 401 through a power supply management system to realize functions of managing charging, discharging, and power consumption management through the power supply management system. The power supply module 403 may also include one or more arbitrary components such as a direct or alternating current power source, a recharging system, a power failure detection circuit, a power converter or inverter, and a power status indicator.

The computer device may also include the input module 404, which may be configured to receive inputted numeric or character information and to produce a keyboard, a mouse, a joystick, and an optical or trackball signal input related to user settings and function controls.

Although not shown, the computer device may further include a display unit or the like. For example, the processing unit 401 in the computer device loads executable files corresponding to processes of one or more application programs into the storage unit 402 according to the following instructions, and the processing unit 401 runs the application programs stored in the storage unit 402, thereby realizing various functions, such as realizing the steps in the above-mentioned data processing method.

It will be appreciated by a person skilled in the art that all or a portion of the steps in the various methods of the above-described embodiments may be performed by instructions, or by control of associated hardware. The instructions may be stored in a readable storage medium (for example, a non-transitory computer-readable storage medium) and loaded and executed by a processor.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

To this end, embodiments of the present disclosure provide one or more non-volatile readable storage media storing a plurality of instructions that can be loaded by a processor to perform steps in any of the methods provided by embodiments of the present disclosure. For example, the instructions may perform the steps in the above-mentioned data processing method.

The one or more non-volatile readable storage media, including a non-transitory computer-readable storage medium, may include: a read only memory (ROM), a random access memory (RAM), a magnetic or optical disk, etc.

The instructions stored in the one or more non-volatile readable storage media may perform the steps in any of the methods provided by embodiments of the present disclosure, therefore, the benefits of any of the methods provided by embodiments of the present disclosure may be realized, as detailed in the preceding embodiments.

According to one aspect of this disclosure, there is provided a computer program product including a computer instruction, and the computer instruction is stored in a storage medium. A processor of the computer device reads the computer instruction from the storage medium, and the processor executes the computer instruction to cause the computer device to perform the method provided in the various alternative implementations of the above-mentioned data processing method.

The data processing method and apparatus, the computer device, and the readable storage medium provided by exemplary embodiments of the present disclosure have been described, and the principles and implementations of the present disclosure have been described herein using specific examples. The above description of the embodiments is provided only to aid in the understanding of the method and aspects of the present disclosure. Other embodiments are within the scope of the present disclosure.

What is claimed is:

1. A data processing method, comprising:
displaying an event setting interface of an event in a first application, the event setting interface including a event data setting element and a data association control element of the event;
receiving event setting data of the event from a user via the event data setting element; and
sending, by processing circuitry, the event setting data of the event to a second application based on a user selection of the data association control element,
wherein the first application is associated with a first service and the second application is associated with a second service that is different from the first service.

2. The method according to claim 1, wherein the displaying the event setting interface comprises:
displaying a messaging interface of the first application;
displaying an event association control element based on a user selection of target messaging content in the messaging interface; and
displaying the event setting interface of the event with the event setting data determined from the target messaging content based on a user selection of the event association control element.

3. The method according to claim 1, wherein the sending the event setting data comprises:
displaying an associated application candidate list based on the user selection of the data association control element;
receiving a user selection of the second application from the displayed associated application candidate list; and
sending the event setting data to the second application selected from the associated application candidate list.

4. The method according to claim 3, wherein the displaying the associated application candidate list comprises:
displaying a login interface based on the user selection of the data association control element;
acquiring login information via the login interface; and
displaying the associated application candidate list based on authentication of the login information.

5. The method according to claim 4, wherein the displaying the associated application candidate list comprises:
displaying an account selection control element in the login interface;
displaying an address book list based on a user selection of the account selection control element;
transmitting a login information acquisition request to a device of a target user based on a user selection of the target user in the address book list; and
receiving the login information from the device of the target user in response to the login information acquisition request.

6. The method according to claim 1, wherein the sending the event setting data comprises:
determining a plurality of participants of the event according to the event setting data based on the user selection of the data association control element; and
sending the event setting data to the second application of each of the participants.

7. The method according to claim 1, wherein the displaying the event setting interface comprises:
displaying a messaging interface of the first application;
displaying an event association control element based on a user selection of target voice content in the messaging interface;
performing voice recognition on voice information included in the target voice content based on the user selection of the event association control element;
generating the event setting data based on the voice recognition; and
displaying the event setting interface of the event with the event setting data determined from the target voice content based on a user selection of the event association control element.

8. The method according to claim 1, wherein the sending the setting data comprises:
displaying an application association authorization interface based on the user selection of the application association control element; and
sending the event setting data to the second application based on login information of the second service associated with the second application being received via the application association authorization interface.

9. The method according to claim 8, wherein the sending the event setting data comprises:
sending the event setting data and the login information to the second service to add the event to the second application.

10. The method according to claim 1, wherein the displaying a setting interface of a reservation event in a first application comprises:
displaying a calendar interface of the first application, the calendar interface including a plurality of date selection elements; and
displaying the event setting interface of the event based on a user selection of a target date via the plurality of date selection elements in the calendar interface, the event setting interface of the event corresponding to the target date.

11. A data processing apparatus, comprising:
processing circuitry configured to:
display an event setting interface of an event in a first application, the event setting interface including an event data setting element and a data association control element of the event;
receive event setting data of the event from a user via the event data setting element; and
send the event setting data of the event to a second application based on a user selection of the data association control element,
wherein the first application is associated with a first service and the second application is associated with a second service that is different from the first service.

12. The data processing apparatus according to claim 11, wherein the processing circuitry is configured to:
display a messaging interface of the first application;
display an event association control element based on a user selection of target messaging content in the messaging interface; and
display the event setting interface of the event with the event setting data determined from the target messaging content based on a user selection of the event association control element.

13. The data processing apparatus according to claim 11, wherein the processing circuitry is configured to:
display an associated application candidate list based on the user selection of the data association control element;
receive a user selection of the second application from the displayed associated application candidate list; and
send the event setting data to the second application selected from the associated application candidate list.

14. The data processing apparatus according to claim 13, wherein the processing circuitry is configured to:
display a login interface based on the user selection of the data association control element;
acquire login information via the login interface; and
display the associated application candidate list based on authentication of the login information.

15. The data processing apparatus according to claim 14, the processing circuitry is configured to:
display an account selection control element in the login interface;
display an address book list based on a user selection of the account selection control element;
transmit a login information acquisition request to a device of a target user based on a user selection of the target user in the address book list; and
receive the login information from the device of the target user in response to the login information acquisition request.

16. The data processing apparatus according to claim 11, wherein the processing circuitry is configured to:
determine a plurality of participants of the event according to the event setting data based on the user selection of the data association control element; and
sending the event setting data to the second application of each of the participants.

17. The data processing apparatus according to claim 11, wherein the processing circuitry is configured to:
display a messaging interface of the first application;
display an event association control element based on a user selection of target voice content in the messaging interface;
perform voice recognition on voice information included in the target voice content based on the user selection of the event association control element;
generate the event setting data based on the voice recognition; and
display the event setting interface of the event with the event setting data determined from the target voice content based on a user selection of the event association control element.

18. The data processing apparatus according to claim 11, wherein the processing circuitry is configured to:
display an application association authorization interface based on the user selection of the application association control element; and
send the event setting data to the second application based on login information of the second service associated with the second application being received via the application association authorization interface.

19. The data processing apparatus according to claim 18, wherein the processing circuitry is configured to:
send the event setting data and the login information to the second service to add the event to the second application.

20. A non-transitory computer-readable storage medium storing instructions which when executed by one or more processors cause the one or more processors to perform:
displaying an event setting interface of an event in a first application, the event setting interface including an event data setting element and a data association control element of the event;
receiving event setting data of the event from a user via the event data setting element; and
sending the event setting data of the event to a second application based on a user selection of the data association control element,
wherein the first application is associated with a first service and the second application is associated with a second service that is different from the first service.
